(19) United States
(12) Patent Application Publication
(10) Pub. No.: US 2002/0089397 A1
(43) Pub. Date: Jul. 11, 2002

(54) Communication device

(76) Inventors: Uno Henningsson, Haninge (SE); Christer Ahlberg, Kolback (SE); Magnus Store, Uppsala (SE); Hamed Jahja, Vasby (SE)

Correspondence Address: Ronald L. Grudziecki, Burns, Doane, Swecker & Mathis , L.L.P., P.O. Box 1404, Alexandria, VA, 22313-1404, US

(21) Appl. No.: 09/982,030

(22) Filed: Oct. 19, 2001

(30) Foreign Application Priority Data
Oct. 20, 2000 (SE) 0003803-4

(51) Int. Cl. H01P 1/20

(52) U.S. Cl. 333/202; 333/227

(57) ABSTRACT

The invention relates to a cavity filter for electromagnetic waves. The cavity filter comprises a first casing element (2) and a second casing element (3), which together define a cavity (1), a tuner (11) of dielectric material and a resonator (8) of dielectric material, which resonator is provided with a through-hole to allow the tuner to move at least partially inside the resonator. The resonator is held stationary in the cavity by means of a tube-shaped first support (9) on a first side of the resonator and a tube-shaped second support (10) on a second side of the resonator. The first support is in contact with the resonator at a first contact surface (24), which is adjacent to a first centring surface (25) at an angle to the first contact surface. The second support is in contact with the resonator at a second contact surface (26), which is adjacent to a second centring surface (27) which is at an angle to the second contact surface. The invention also relates to the resonator and a method for assembling the cavity filter.

### TECHNICAL FIELD OF THE INVENTION

The present invention relates in general to a method for assembling a cavity filter for electromagnetic waves. The invention also relates to a cavity filter and a dielectric resonator.

### DESCRIPTION OF RELATED TECHNOLOGY

In, for example, radio base stations, cavity filters are used for filtering, for example, microwaves of particular frequencies from different transmitters to a shared antenna. A hollow dielectric body, a so-called resonator, is often used in a cavity filter to produce resonance in a cavity at a particular frequency. The resonator is often held in place in the cavity by a ceramic support, which is a good conductor of heat and is fixed to the resonator by gluing. Due to the electrical field that is principally generated in the resonator, there is an unwanted production of heat in this. There is therefore a desire to conduct heat away from the resonator to the casing of the cavity through the support, but in addition to the gluing taking time, it also reduces the conduction of heat from the resonator to the support.

U.S. Pat. No. 4,667,172, which is hereby incorporated as a reference, shows a cavity filter for radio waves. A cavity is defined by a housing with a cover. A resonator in the cavity is attached to the housing and the cover by a lower washer lying against the housing, a lower support, an upper support and a spring washer lying against the cover. The cover and a bottom plate of the housing are provided with recessed grooves to receive the lower washer and the spring washer respectively. A tuner can be partially inserted into the resonator in order to change the resonance frequency. This tuner cannot be replaced without the cover being firstly removed from the housing. In addition, the tuner is not adjusted by a motor, which means that the resetting to a different frequency cannot be carried out automatically, but must be carried out by a time-consuming manual process.

It has been found that a very important predetermined dimension in the design of reliable cavity filters is the distance between an input device and the resonator. This distance should be kept as close as possible to an optimal distance, that is the tolerance for the required distance should be as small as possible. The radio frequency filter that is described in the abovementioned document is not, however, able to achieve a small tolerance in a way that is simple and cheap to manufacture. This is partly because the input device is fixed horizontally in the housing and the spring washer lies in the groove in the cover and exerts a force on the resonator in a direction away from the cover. In addition to tolerances in manufacturing the various components themselves, there are tolerances associated with the horizontal fixing of the input device in the housing. The fixing between the cover and the housing also contributes to the final tolerance. In addition, the spring washer results in a varying distance between the cover and the resonator, which distance depends upon the tolerances in the groove in the cover, the cover itself, the groove in the housing, the housing itself, an O-ring, the lower washer, the lower support, the resonator, the upper support and the spring washer.

The lower support has a raised step that is inserted in a central hole in the resonator. This step prevents the tuner from being fully inserted in the central hole in the resonator. A disadvantage of this is that the bandwidth of an adjustable resonance frequency is narrower than if the tuner could be inserted right down to the lower aperture of the central hole.

### SUMMARY

A first aim of the present invention is to achieve a cavity filter with a dielectric resonator that does not need to be glued to a support in order to be fixed in a cavity. A second aim is to achieve a cavity filter with reduced tolerance for a required distance between an input device, an output device and the resonator in three dimensions, without preventing a tuner being able to pass through the resonator. A third aim is to reduce the tolerance between a first casing element and a second casing element, which together define a cavity. A fourth aim is to save work by the input device and/or the output device not needing to be trimmed. A fifth aim is to make easier the assembly and centring of a cavity filter with two resonator supports. A sixth aim is to be able to fulfil easily flatness requirements for supporting surfaces in order to further reduce the tolerances for the cavity filter, and in particular the distance between the input device and the resonator and the output device and the resonator. Additional aims, effects and advantages will be apparent from the following description.

The invention therefore relates to a method for assembling a cavity filter for electromagnetic waves, in order to be able easily to place a resonator and at least one connection device for sending or receiving electromagnetic waves in predetermined positions with as small a tolerance as possible for the distance between the resonator and the connection device. The method comprises the steps of:

placing a spring washer in a recess in a first casing element;

placing a tube-shaped first support in the recess so that the first support is in contact with the spring washer;

placing the resonator on the first support using a first contact surface and a first centring surface which is at an angle to and adjacent to the first contact surface, which first contact surface and first centring surface are located on the first support or the resonator;

placing a tube-shaped second support on the resonator using a second contact surface and a second centring surface which is at an angle to and adjacent to the second contact surface, which second contact surface and second centring surface are located on the second support or the resonator;

fixing a second casing element, comprising a base surface in a first plane, a ring-shaped first supporting surface in a second plane, and a ring-shaped second supporting surface essentially in the second plane, on the second casing element [sic] in such a way that the second support is in contact with the second supporting surface and the first supporting surface is in contact with the first casing element.

The invention also relates to a cavity filter for electromagnetic waves, comprising:

a first casing element;

a second casing element, which together with the first casing element defines a cavity and has a side with a base surface, a ring-shaped first supporting surface, a ring-shaped second supporting surface, where the base surface is in a first plane and the first and the second supporting surfaces are in a second plane;

a tuner of dielectric material;

a resonator of dielectric material which is provided with a through-hole to allow the tuner to move inside the resonator;

a tube-shaped first support of dielectric material on a first side of the resonator and a tube-shaped second support of dielectric material on a second side of the resonator;

where the first support is in contact with the resonator at a first contact surface, which is adjacent to a first centring surface at an angle to the first contact surface, and the second support is in contact with the resonator at a second contact surface, which is adjacent to a second centring surface which is at an angle to the second contact surface, and the first supporting surface of the second casing element is in contact with the first casing element and the second supporting surface is in contact with the second support.

As it is easier to fulfil flatness requirements for supporting surfaces that have a small area in comparison to supporting surfaces that have a larger area, the second casing element has been designed with the first and second supporting surfaces, which supporting surfaces together have a surface area that is smaller than a corresponding side, with only one base surface that acts as supporting surface for both the first casing element and the second support. As the first support is in the shape of a tube, the tuner can also be inserted into the resonator and at least partly into the first support.

The first and the second contact surfaces are preferably flat and circular in the shape of a ring with a respective internal diameter and a respective external diameter, where the first centring surface is essentially circular and at right angles to the first contact surface and the second centring surface is essentially circular and at right angles to the second contact surface. By this means, a more certain centring is achieved than if the centring surfaces had been at a smaller angle to the contact surfaces. It is also quicker to manufacture the centring surfaces in this way.

In a first embodiment of the cavity filter, a first side of the resonator comprises the first contact surface and the first centring surface, where the first support has an essentially constant cross-section with an essentially circular outer contour. The second side of the resonator preferably also comprises the second contact surface and the second centring surface, where the second support has an essentially constant cross-section with an essentially circular outer contour. The external diameter of the first contact surface is here suitably smaller than the external diameter of the second contact surface and these external diameters correspond to the external diameters of the first support and the second support respectively, so that the second support has an external diameter which is larger than an external diameter of the first support. In this way, the assembler can more easily distinguish between the first and the second supports. By this means, the assembly is made even easier.

In a first alternative of the first embodiment, the first and the second centring surface are turned radially inwards towards an axis of symmetry of the resonator. In a second alternative of the first embodiment, the first and the second centring surfaces are turned radially outwards from an axis of symmetry of the resonator.

In a second embodiment of the cavity filter, the first support comprises the first contact surface and the first centring surface. In addition, the second support comprises the second contact surface and the second centring surface.

In a first alternative of the second embodiment, the first centring surface and the second centring surface are turned radially inwards towards an axis of symmetry of the first and second supports respectively. In a second alternative, the first and the second centring surfaces are turned radially outwards from an axis of symmetry of the first and second supports respectively.

In a third embodiment, the first and the second centring surfaces constitute parts of a cylindrical outer surface of a hollow centring tube.

In order to prevent incorrect assembly and to centre the first support, at least a part of the first support has an external diameter that corresponds to the diameter of a circular ring-shaped recess in the first casing element. This part of the first support is at least partially inserted into the circular ring-shaped recess.

A spring washer is preferably placed in the circular ring-shaped recess in the first casing element in such a way that the spring washer exerts a compressive force on the first support in a direction towards the second casing element. By this means, the position of the resonator in relation to the second casing element is ensured.

The second casing element has suitably an opening which is so large that the opening allows the tuner to be inserted into or removed from the cavity, even if the second casing element is fixed to the first casing element. By this means, a cavity filter is achieved where the second casing element does not need to be removed for replacing the tuner. The second casing element also comprises through-openings for receiving an input device for supplying electromagnetic waves into the cavity and an output device for tapping off electromagnetic waves from the cavity.

The invention also relates to a resonator of dielectric material which is designed to operate in a cavity in a cavity filter for electromagnetic waves. The resonator has a circular outer contour and comprises a circular through-hole in order to allow a tuner to move at least partially inside the through-hole, a first contact surface, a first centring surface at an angle to and adjacent to the first contact surface, a second contact surface, and a second centring surface at an angle to and adjacent to the second contact surface.

### BRIEF DESCRIPTION OF THE FIGURES

The aims, advantages and effects, and the characteristics of the present invention will be understood more easily as a result of the following detailed description of embodiments, where the description is to be read in conjunction with the enclosed drawings, in which:

FIG. 1 shows a cross-sectional view of a cavity filter according to a first embodiment;

FIG. 2 shows a second casing element in the form of a cover according to the first embodiment viewed from underneath;

FIG. 3 shows a resonator according to the first embodiment viewed from above;

FIG. 4 shows the resonator in FIG. 3 viewed from below;

FIG. 5 shows a view from above of a spring washer according to the first embodiment;

FIG. 6 shows a cross-section of a cavity filter according to a second embodiment;

FIG. 7 shows a cross-section of a cavity filter according to a third embodiment;

FIG. 8 shows a cross-section of a cavity filter according to a fourth embodiment; and

FIG. 9 shows a cross-section of an alternative embodiment of a resonator.

### DETAILED DESCRIPTION OF EMBODIMENTS

While the invention covers various modifications and alternative designs, various embodiments of the invention are shown in the drawings and will be described in detail below. It should, however, be understood that the special description and the drawings are not intended to limit the invention to the specific forms shown. On the contrary, it is intended that the scope of the invention to which the application refers comprises all modifications and alternative designs thereof that fall within the concept and scope of the invention as expressed in the attached claims.

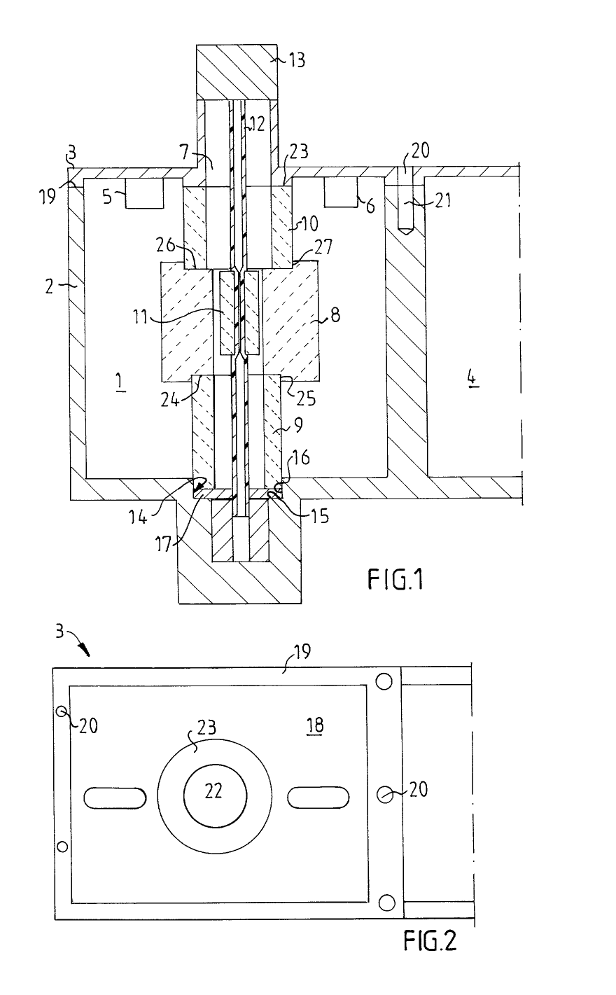

FIG. 1 shows a cross-section of a first embodiment according to the invention of a cavity filter. Here a cavity 1 for electromagnetic waves, such as microwaves, is defined by a first casing element in the form of a casing 2 and a second casing element in the form of a cover 3. The cavity 1 is here essentially parallelepiped, but can also be cylindrical. Both the casing 2 and the cover 3 can be designed for only one cavity 1, or as indicated in the right-hand part of FIG. 2, [sic] can house one or more additional cavities 4 for more cavity filters. An input device in the form of an input loop 5 and an output device in the form of an output loop 6 for supplying and tapping off frequencies are inserted essentially vertically through holes 7 in the cover 3 and at least partially into the cavity 1. An axially rotationally-symmetrical hollow ceramic resonator 8 is placed inside the cavity 1, by the resonator 8 being supported by a cylindrical and axially rotationally-symmetrical hollow first support 9 and a cylindrical and axially rotationally-symmetrical hollow second support 10. The supports 9, 10, can be made of, for example, aluminium oxide or quartz glass, and are not only designed to support the resonator 8, but are also used to conduct heat away from the resonator 8. The holes in the supports 9, 10 and the resonator 8 are cylindrical and concentric in relation to each other, in order to allow a tuner 11 to move vertically in and out of the hole in the resonator 8 by means of a spindle 12 of dielectric material, such as plastic or ceramic, and a motor 13 connected to the spindle. The tuner 11 is made of dielectric material, such as ceramic with a high dielectric constant, and upon insertion into the dielectric resonator 8, the tuner 11 changes the resonance frequency of the cavity filter. In this way, the resonance frequency can be changed linearly, where the lowest resonance frequency is attained when as much as possible of the mass of the tuner 11 is inserted into the hole in the resonator 8. The movement of the tuner 11 does not constitute any part of the present invention and is therefore not described in greater detail. The principle functions of the cavity 1, the resonator 8, the input loop 5 and the output loop 6 for a cavity filter are well-known to an expert within the technical field and are therefore also not described in greater detail.

The casing 2 has a bottom with a circular ring-shaped recess 14. The recess has an essentially flat, circular ring-shaped stop surface 15 that is horizontal in FIG. 1 and a circular ring-shaped guide surface 16 essentially at right angles to the stop surface 15. A spring washer 17 is in contact with at least the stop surface 15 of the recess 14 and the first support 9 is placed above the spring washer 17 in order to act as a centring support for the resonator 8. The diameter of the guide surface 16 corresponds essentially to the external circumference of the spring washer 17 and of the first support, so that the guide surface 16 acts as a guide for the spring washer 17 and the first support 9 relative to the casing 2 during assembly and prevents radial movement of the spring washer 17 and the first support 9 during and after assembly.

FIG. 2 shows the underside of the cover, comprising a base surface 18 that is horizontal in FIG. 1 and an edge projecting relative to the base surface (downwards in FIG. 2). The projecting edge defines an essentially flat, ring-shaped first supporting surface 19 that is horizontal in FIG. 1. A plurality of through-holes 20 for screws open into the first supporting surface in order to fix the cover 3 to the casing 2 by means of screws (not shown) and corresponding holes 21 in the casing 2. The cover 3 has a circular continuous opening 22, which opening is so large that it allows the tuner 11 to be taken out of the cavity 1 without the necessity to remove the cover 3, for example when replacing the tuner 11. The circular opening 22 opens into a flat ring-shaped second supporting surface 23, that is horizontal in FIG. 1. The second supporting surface 23 is in essentially the same plane as the first supporting surface 19. The second supporting surface 23 is preferably circular, but can have, for example, a square outer contour.

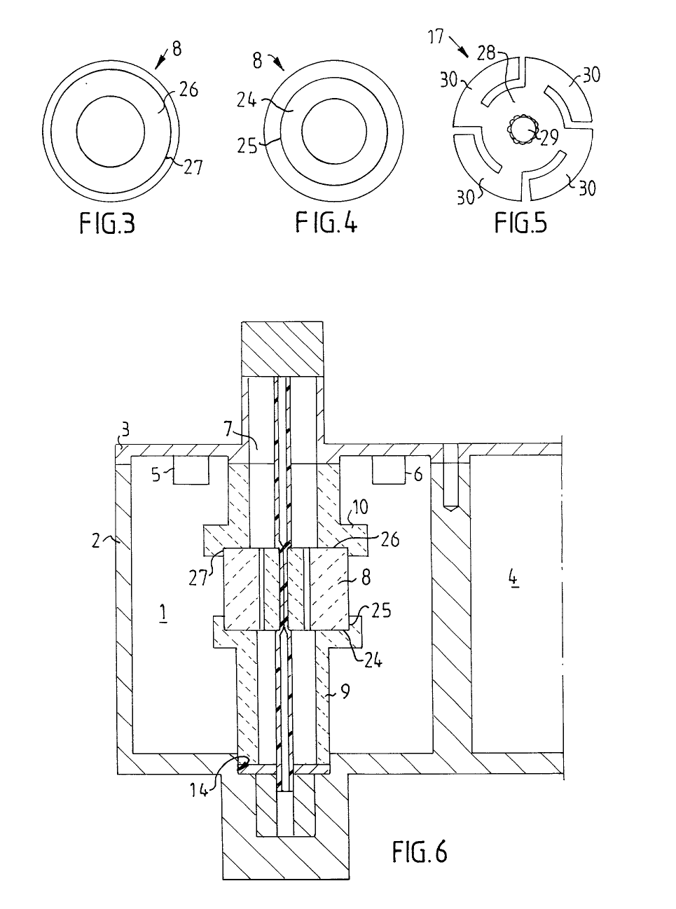

The design of the resonator according to the first embodiment will now be described with reference to FIGS. 1, 3 and 4. As shown in FIGS. 3 and 4, the hollow resonator 8 is cylindrical, and comprises a concentric cylindrical upper recess and a concentric cylindrical lower recess. The lower cylindrical recess provides an essentially flat, ring-shaped first contact surface 24 that is horizontal in FIG. 1 for contact with an upper end of the first support 9. The lower recess also provides a ring-shaped first centring surface 25 turned inwards towards the centre of the lower recess, that is the perpendicular of the first centring surface 25 points towards the axis of symmetry of the resonator 8. The diameter of the first centring surface 25 corresponds to the external diameter of the first support 9. The purpose of the first centring surface 25 of the lower recess is to guide and centre the first support 9 in relation to the resonator 8 so that the first support 9 and the resonator 8 are and remain essentially concentric. The upper recess provides an essentially flat, ring-shaped second contact surface 26 that is horizontal in FIG. 1 for contact with a lower end of the second support 10, which is thus used as a position-fixing support for the resonator 8 in relation to the cover 3. The upper recess also provides a ring-shaped second centring surface 27 turned inwards towards the centre of the upper recess, that is the perpendicular of the second centring surface 27 points towards the axis of symmetry of the resonator 8. The diameter of the second centring surface 27 corresponds to the external diameter of the second support 10. The purpose of the second centring surface 27 of the upper recess is to guide and centre the second support 10 in relation to the resonator 8 so that the second support 10 and the resonator 8 are and remain essentially concentric. It should be noted that the external diameter of the second support 10 is not the same as the external diameter of the first support 9, which means that the resonator 8 is only rotationally-symmetrical around its axis of symmetry running parallel with its hole. The reason for giving the supports 9, 10 different external diameters is that the supports 9, 10 and the resonator 8 can thus only be assembled in one possible way. In this embodiment, the first support 9 has an essentially smaller external diameter than the second support 10, which means that the second support 10 cannot be inserted into the recess 14 in the housing. An assembler then realizes that he/she has incorrectly attempted to insert the second support 10 into the recess 14. If, contrary to expectation, the assembler puts the second support 10 in the cavity 1, without noticing that the second support 10 has not been received in the recess 14, and thereafter inserts the resonator 8 with the lower recess in the resonator towards the second support 10, the assembler will notice that the resonator 8 cannot be fitted into the second support 10. If the assembler has inverted the resonator 8, it will then of course fit into the incorrectly placed second support 10, and the first support 9 can be fitted into the resonator 8 above this. This time, however, the assembler will notice that something is wrong, as it will not be possible to close the cavity 1 with the cover 3. Nor can the cavity 1 be closed when the first support 9 has been received in the recess 14 in the casing but the resonator 8 has been inverted. It is thus impossible for the assembler to assemble the resonator 8 in an incorrect way without it being noticeable upon closing the cavity 1, if for some reason it was not noticed at an earlier stage.

FIG. 5 shows the spring washer 17 that is used to take up clearances between the cover 3, the supports 9, 10, the resonator 8 and the casing 2. The plane of the ring-shaped second supporting surface 23 of the cover constitutes the reference level to which at least the input loop 5, the output loop 6, the supports 9, 10 and the resonator 8 are related. As the spring washer 17 ensures that the resonator 8 is always in a particular final position in relation to the second supporting surface 23 of the cover 3 and as the positions of the input loop 5 and the output loop 6 in relation to the supporting surface are also determined without allowing for any significant tolerances, the distance between, for example, the input loop 5 and the resonator 8 can be predetermined with a minimum of tolerances, which is very important for predicting the electromagnetic field that is generated in the cavity 1. The spring washer 17 is designed with an essentially flat circular central part 28 with a central hole 29 which is shaped as a star with blunt points. The spring washer 17 also comprises four tongues 30 that act as cantilevered leaf springs. These tongues 30 each have one end attached to the central part, this end being integral with a part of the periphery of the central part 28. From the periphery of the central part 28 the four tongues 30 extend first radially outwards in the same plane as the central part and essentially at right angles in relation to each other. Thereafter the tongues 30 each change to an outer part that extends in a spiral away from the plane of the central part. In order that the free end of a tongue 30 does not overlap an adjacent tongue when the spring washer 17 is compressed and thereby create uneven distribution of pressure on the spring washer 17 and the first support 9, while at the same time fitting into the recess 14 in the housing, the length of the outer part is chosen so that it corresponds to an outer segment of a sector of a circle that extends over an angle that is less than 90°.

FIG. 6 shows a second example of an embodiment of the invention. Here the lower end of the second support 10 is designed with the upper recess, which forms a flat, ring-shaped second contact surface 26 that is horizontal in FIG. 6 for contact with the upper end of the resonator 8, which here is cylindrical and in the form of a tube without recesses. The upper recess in the second support 10 also forms the ring-shaped second centring surface 27 that is turned inwards towards the centre of the upper recess, that is the perpendicular of the second centring surface 27 points essentially towards the axis of symmetry of the second support 10. In the same way as the second support is designed with the upper recess, the first support 9 is provided with the cylindrical and concentric lower recess with the first contact surface 24 and the first centring surface 25 respectively for contact with and guiding of the lower end of the resonator 8. In order not to confuse the first support 9 with the second support 10, the lower end of the first support 9 can have an external diameter that fits the ring-shaped recess 14 in the casing 2, while the upper end of the second support 10 has an external diameter that is too large to fit in the ring-shaped recess 14 in the casing 2.

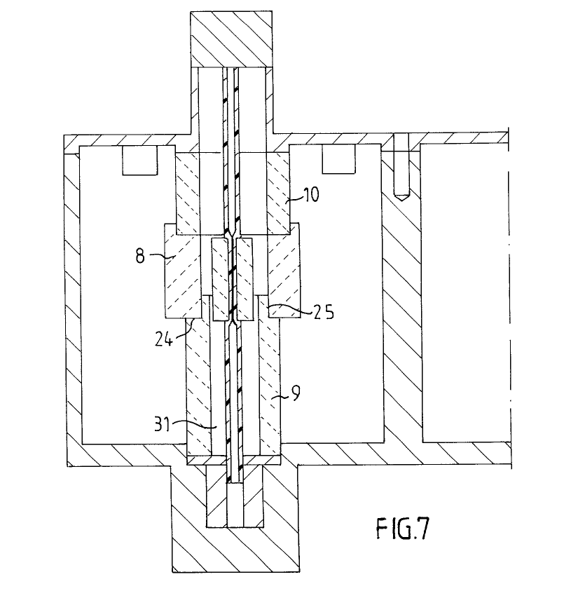

FIG. 7 shows a third embodiment, where the second support 10 is in contact with the resonator 8 in the same way as in the first embodiment. The first support 9, on the other hand, has a preferably cylindrical hole 31 that is smaller than the through-hole in the resonator 8. The resonator 8 has here no lower recess, the bottom end of the resonator 8 being essentially cylindrical and tube-shaped. Instead, on the upper end of the first support 9, there is a concentric and ring-shaped first contact surface 24 that is horizontal in FIG. 7. The ring-shaped first contact surface 24 has an internal diameter that is larger than the diameter of the cylindrical hole 31 in the first support 9 and corresponds to the internal diameter of the resonator 8. This means that the first centring surface 25 is here ring-shaped and is turned radially outwards from the centre of the cylindrical hole 31. The first centring surface 25 therefore acts as a guide against the wall of the through-hole in the resonator 8.

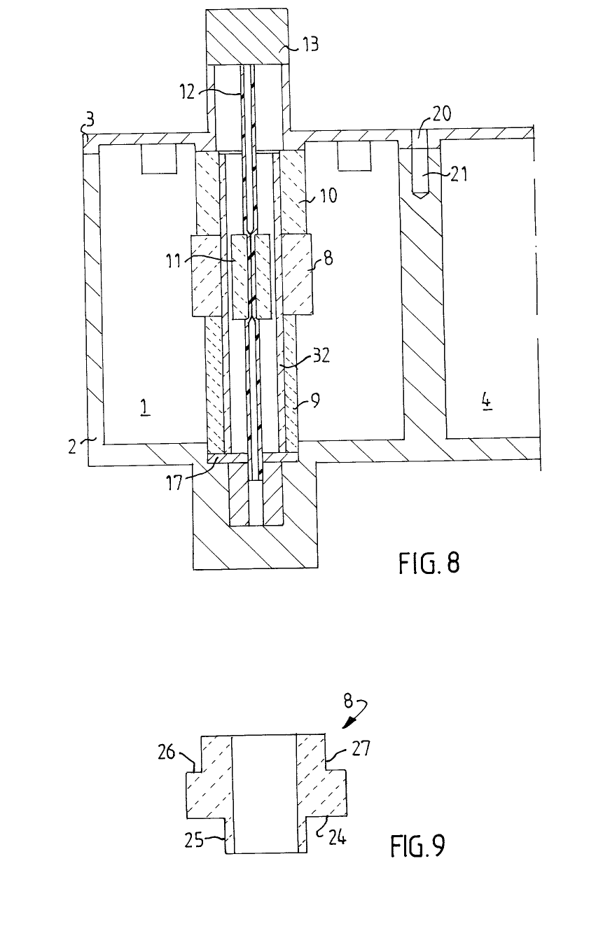

FIG. 8 shows a fourth embodiment of the cavity filter, where the first and second centring surfaces constitute parts of an outer surface of a circular centring tube 32 made, for example, of glass. The external diameter of the centring tube 32 thus corresponds to the internal diameter of the supports, 9 and 10 respectively, and the concentric through-hole in the resonator 8 for receiving the tuner 11. Alternatively, but not shown, the first and the second centring surfaces can constitute parts of a cylindrical inner surface of a centring tube that surrounds the supports and the resonator, that is that lies outside the supports and the resonator. The supports and the resonator are here circular and tube-shaped with essentially the same external diameter, which corresponds to the diameter of the inner surface of the centring tube.

FIG. 9 shows a third embodiment of the resonator 8, that here has a circular ring-shaped first recess at one end of the resonator 8 and a ring-shaped second recess at the other end of the resonator 8. The internal diameter of the first recess is larger than the diameter of the through-hole, and corresponds to an internal diameter of the first support 9, which in this embodiment can be essentially the same shape as in the first embodiment of the invention (the one shown in FIG. 1). In this way, a first contact surface 24 is formed for the first support 9. In the same way, a second contact surface 26 for the second support 10 is formed by the second recess. The internal diameter of the second recess is preferably larger than the internal diameter of the first recess. The first recess also provides the resonator 8 with a first centring surface 25, which is circular and ring-shaped and is turned radially outwards from the axis of symmetry of the resonator 8. In the same way, the second recess also provides the resonator with a second centring surface 27, which is also circular and ring-shaped and is turned radially outwards from the axis of symmetry of the resonator 8.

Even though only a few embodiments are shown in the figures, it is to be understood that more other embodiments with corresponding contact surfaces, centring surfaces and guide surfaces are possible within the scope of the invention. For example, the hole for the tuner in the supports 9, 10 and the resonator 8, and the supports 9, 10 and the resonator 8 themselves do not need to have a circular outer contour, but can be other suitable shapes, such as a square shape. The outer contours and inner contours of the resonator and the supports can also gradually taper inwards and/or outwards in the axial direction of their holes.

The size of the cavity filter can also affect the design of the various components. For example, with relatively small cavities the spring washer can comprise two or three tongues instead of the spring washer 17 with four tongues shown in FIG. 5.

It is also to be understood that instead of loops as input and output devices, the cavity filter can be supplied with electromagnetic waves via other types of connection devices for electromagnetic fields, such as a probe or a window.

1. A cavity filter for electromagnetic waves, comprising:
a first casing element (2);
a second casing element (3), which together with the first casing element (2) defines a cavity (1) and is provided with through-openings for receiving an input device (5) for supplying electromagnetic waves into the cavity (1) and an output device (6) for tapping off electromagnetic waves from the cavity (1), and has a side with a base surface (18), a ring-shaped first supporting surface (19), a ring-shaped second supporting surface (23), where the base surface (18) is in a first plane and the first and the second supporting surfaces (19, 23) are in a second plane;
a tuner (11) of dielectric material;
a resonator (8) of dielectric material which is provided with a through-hole to allow the tuner (11) to move inside the resonator (8);
a tube-shaped first support (9) of dielectric material on a first side of the resonator (8) and a tube-shaped second support (10) of dielectric material on a second side of the resonator (8);
where the first support (9) is in contact with the resonator (8) at a first contact surface (24), which is adjacent to a first centring surface (25) at an angle to the first contact surface (24), and the second support (10) is in contact with the resonator (8) at a second contact surface (26), which is adjacent to a second centring surface (27) which is at an angle to the second contact surface, and the first supporting surface (19) of the second casing element (3) is in contact with the first casing element (2) and the second supporting surface (23) is in contact with the second support (10).

2. A cavity filter according to claim 1, where the first and the second contact surfaces (24, 26) are essentially flat and circular in the shape of a ring with a respective internal diameter and a respective external diameter, where the first centring surface (25) is essentially circular and at right angles to the first contact surface (24) and the second centring surface (27) is essentially circular and at right angles to the second contact surface (26).

3. A cavity filter according to claim 2, where the resonator (8) comprises the first contact surface (24) and the first centring surface (25), and where the first support (9) has an essentially constant cross-section with an essentially circular outer contour.

4. A cavity filter according to claim 2, where the resonator (8) comprises the second contact surface (26) and the second centring surface (27), and where the second support (10) has an essentially constant cross-section with an essentially circular outer contour.

5. A cavity filter according to claim 2, where the resonator (8) comprises the first contact surface (24) and the first centring surface (25) on the first side of the resonator (8), and the second contact surface (26) and the second centring surface (27) on the second side of the resonator (8).

6. A cavity filter according to claim 5, where the external diameter of the first contact surface (24) is smaller than the external diameter of the second contact surface (26).

7. A cavity filter according to claim 6, where the first and the second centring surfaces (25, 27) are turned radially inwards towards an axis of symmetry of the resonator (8).

8. A cavity filter according to claim 5, where the internal diameter of the first contact surface (24) is smaller than the internal diameter of the second contact surface (26).

9. A cavity filter according to claim 8, where the first and the second centring surfaces (25, 27) are turned radially outwards from an axis of symmetry of the resonator (8).

10. A cavity filter according to claim 2, where the first support (9) comprises the first contact surface (24) and the first centring surface (25).

11. A cavity filter according to claim 10, where the first centring surface (25) is turned radially inwards towards an axis of symmetry of the first support (9).

12. A cavity filter according to claim 10, where the first centring surface (25) is turned radially outwards from an axis of symmetry of the first support (9).

13. A cavity filter according to claim 2, where the second support (10) comprises the second contact surface (26) and the second centring surface (27).

14. A cavity filter according to claim 13, where the second centring surface (27) is turned radially inwards towards an axis of symmetry of the second support (10).

15. A cavity filter according to claim 2, where the first and the second centring surfaces (25, 27) constitute parts of a cylindrical outer surface of a hollow centring tube (32).

16. A cavity filter according to claim 1, where at least a part of the first support (9) has an external diameter that corresponds to the diameter of a circular ring-shaped recess (14) in the first casing element (2) and where this part of the first support (9) is at least partially inserted into the circular ring-shaped recess (14).

17. A cavity filter according to claim 16, comprising a spring washer (17) that is placed in the circular ring-shaped recess (14) in the first casing element in such a way that the spring washer (17) exerts a compressive force on the first support (9) in a direction towards the second casing element (3).

18. A cavity filter according to claim 1, where the second support (10) has an external diameter that is larger than an external diameter of the first support (9).

19. A cavity filter according to claim 1, where the second casing element (3) has an opening (22) which is so large that the opening (22) allows the tuner (11) to be inserted into or removed from the cavity (1), even if the second casing element (3) is fixed to the first casing element (2).
